(19) United States
(12) Patent Application Publication
(10) Pub. No.: US 2007/0244955 A1
(43) Pub. Date: Oct. 18, 2007

(54) METHOD FOR LOCATING A SERVO MOTOR CONTROLLER

(76) Inventors: Yu-Li Wang, Taipei City (TW); Chia-Hsing Fu, Gueishan Township (TW)

Correspondence Address: Dykema Gossett, PLLC, Suite 300 West, 1300 I Street, N.W., Washington, DC, 20005-3306, US

(21) Appl. No.: 11/688,459

(22) Filed: Mar. 20, 2007

(30) Foreign Application Priority Data
Mar. 21, 2006 (TW) 95109712

(51) Int. Cl. G06F 7/52

(52) U.S. Cl. 708/628

(57) ABSTRACT

The method of locating a servo motor controller's position of the present invention utilizes accrual calculation method to ensure the positions of motor controller at each station of the production line is correctly obtained, wherein the last digit of the gear ratio is utilized to obtain a critical value so that the inputted pulse value and the gear ratio are be calculated to result a quotient and a remainder. The remainder is compared with the critical value first in order to determine the following processes of the quotient, the remainder and the last digit of gear ratio. The quotient and the remainder are stored in the quotient temporary storage device and remainder temporary storage device respectively to ensure the actual pulse value of the motor will not be cumulated with the position calculating errors.

### BACKGROUND OF THE INVENTION

1. Field of Invention

The present invention relates, particularly, the present invention relates a method locating a servo motor controller's position to prevent the cumulation of the calculating error.

2. Description of the Related Art

Present-day society increasingly relies on automatic machineries as machineries become more essential in everyday life. Various techniques have been developed to increase the efficiency of the automatic machineries. In the current industries, from the distribution of raw materials, the fabricating process of various components, the assembly line, testing and to the transportation process of the final products, are all done automatically. For the automatic production line, the main driving force of the production line is the motor.

During the manufacture process, an uncompleted product has to go through several various processing stations, wherein each station has designed to perform a particular manufacturing task. Since the main purpose of the automatic production line is to cut down the man force in the production, therefore, a lot of processes of the automatic production line are proceeded without any human involvement. As a result, the accuracy of the motor's position at every station is very important to ensure the product is conveyed correctly from one station to another so that the product can be processed according to the designed manufacturing plan in order to improve the quality of product.

When the conventional method of locating the rotating angle of the motor is utilized on the linear movement or the rotating movement of the decreasing speed machine or the applying electrical gear ratio, the actual pulse value of the motor is obtained from calculating the inputted actual pulse value with the exchange ratio. However, when the quotient/result of the division cannot be an integer, i.e. when the dividend cannot be divided fully by the divisor, then the processor will apply an round-to-even method to round the sum to its 1^{st} place, either increasing it by 1 when a next digit is 5 or more, or leave it the same if the next digit is 4 or less. This conventional method normally results the cumulating the calculation error, resulting the final result of the motor's position is completely well off from the accurate position of the motor. Therefore, the position of the motor cannot be located easily at a correct place, as a result, the production line can be severely affected, and the quality of the product can be affected and damaged.

The objective of the present invention is to provide an improved method of calculating the motor's position so that the motor can be located more actually.

### SUMMARY OF THE INVENTION

It is an object of the present invention to provide a locating method for a servo motor controller without the cumulating the calculation error, wherein the method comprises the following steps:
(1) dividing a last digit of a gear ratio by 2 to obtain a sum, and applying an round-to-even method to round the sum to its 1^{st} place, either increasing it by 1 when a next digit is 5 or more, or leave it the same if the next digit is 4 or less, wherein the obtained sum of the division is used as a critical value;
(2) inputting a commend pulse value;
(3) multiplying the commend pulse value by a first digit of the gear ratio, and dividing the obtained quantity of the division by the last digit of the gear ratio to produce a quotient and a remainder, wherein the remainder is added to a remainder of a remainder temporary storage device to obtain a sum and the remainder sum is stored within the remainder temporary storage device;
(4) determining whether the sum of the remainder temporary storage device is greater than or equal to the critical value, if it is no, the system will proceed to step (6), otherwise the system will proceed to the following step;
(5) adding the quotient by 1, and subtracting the sum of the remainder temporary storage device by the last digit of gear ratio in such that the final result is stored within the remainder temporary storage device;
(6) adding the quotient by a quotient of a quotient temporary storage device, and saving the obtained quotient sum in the quotient temporary storage device; and
(7) rotating a motor to a calculated position according to the obtained quotient sum of the quotient temporary storage device, and then proceed to step (2).

Both the forgoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the present invention together with the description and serve to explain the principles of the invention. In the drawings,

FIG. 1 is a schematic diagram showing how a system to locate a servo motor controller in accordance with a preferred embodiment of the present invention; and

FIG. 2 is a flow-chart illustrating a method of locating a servo motor controller in accordance with a preferred embodiment of the present invention.

### DESCRIPTION OF THE PREFERRED EMBODIMENTS

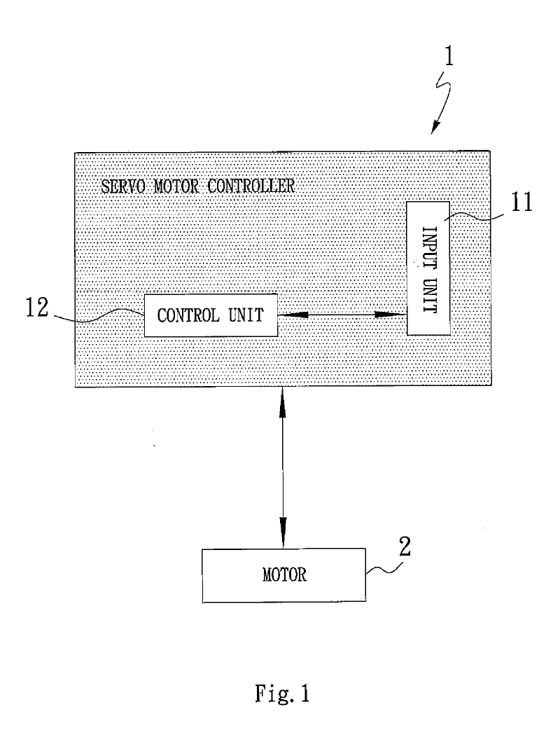

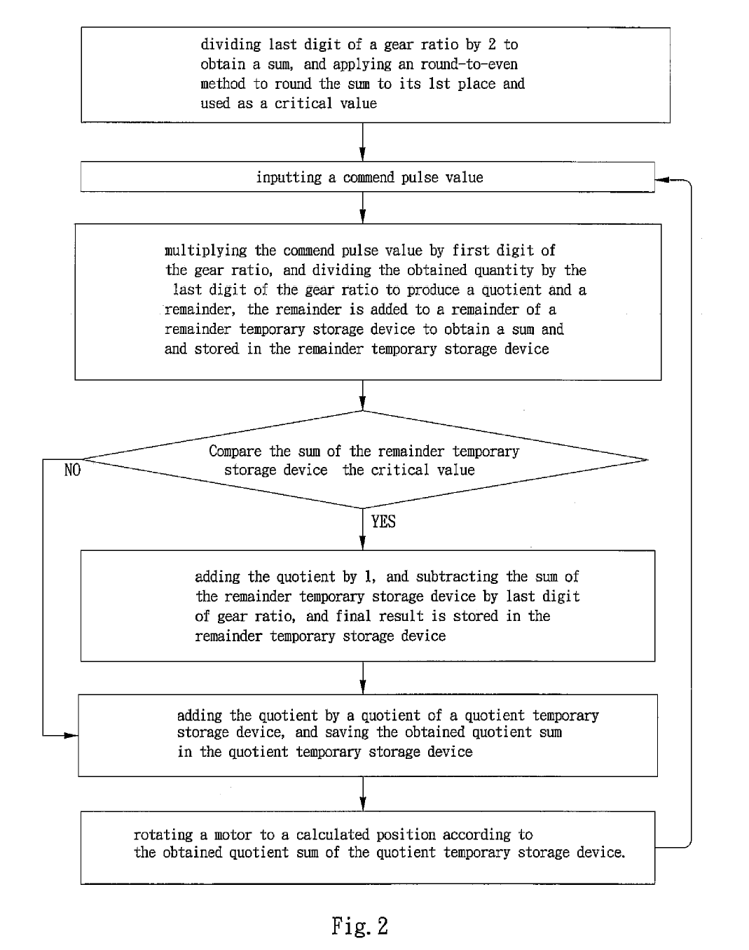

FIG. 1 is a schematic diagram showing how a system to locate a servo motor controller in accordance with a preferred embodiment of the present invention; FIG. 2 is a flow-chart illustrating a method of locating a servo motor controller in accordance with a preferred embodiment of the present invention.

A driving system of a servo motor controller 1 comprises an input unit 11 and a control unit 12, wherein the driving system 1 controls a motor 2 rotating to a predetermined position.

The locating method for a servo motor controller of the present invention, comprises the following steps:
(1) dividing a last digit of a gear ratio by 2 to obtain a quotient or a sum, and applying an round-to-even method to round the final sum to its 1^{st} place (units place) without decimal digit, either increasing it by 1 when the next digit is 5 or more, or leave it the same if the next digit is 4 or less, wherein the final sum is then used as a critical value and the gear ratio is produced by a feedback signal;
(2) inputting a commend pulse value, wherein the pulse value is produced by the input unit 11, and the input unit 11 can be a host controller, an internal memory or a signal processor;
(3) multiplying the commend pulse value by a first digit of the gear ratio, and dividing the obtained quantity by the last digit of the gear ratio to produce a quotient and a remainder, wherein both the quotient and the remainder are produced in the control unit 12, the remainder is added to a remainder of a remainder temporary storage device, in which both remainders are then stored in the remainder temporary storage device, the calculation of the quotient and the remainder in the control unit 12 can be processed via the hardware processor of a complex programmable logic device (CPLD), or a field programmable gate array (FPGA) or a application specific integrated circuit (ASIC), and a software processor;
(4) determining whether the sum of the remainder temporary storage device is greater than or equal to the critical value, if it is no, the system will proceed to step (6), otherwise the system will proceed to the following step;
(5) adding the quotient by 1 and subtracting the sum of the remainder temporary storage device by the last digit of gear ratio in such that the final result is stored within the remainder temporary storage device;
(6) adding the quotient by a quotient of a quotient temporary storage device, and saving the sum in the quotient temporary storage device; and
(7) rotating the motor 2 to a calculated position according to the quotient sum of the quotient temporary storage device, and then proceed to step (2).

A preferred example is used to demonstrate how the present invention can calculate and locate the position of a servo motor controller. Assuming a gear ratio is 1:3, and the inputted commend pulse value is 1000,
(1) dividing a last digit of a gear ratio by 2 to obtain a quotient or a sum, 3/2=1.5, and applying an round-to-even method to round the final quotient/sum to its 1^{st} place, 1+1=2, therefore the critical value is 2;
(2) inputting the commend pulse value 1000;
(3) multiplying 1000 by 1=1000, and dividing the sum by last digit gear ratio 3, 1000/3=333 (quotient) . . . 1 (remainder), wherein the remainder 1 is added by a remainder of a remainder temporary storage device, 1+0=1, the sum 1 is then stored in the remainder temporary storage device;
(4) determining whether the sum of the remainder temporary storage device is greater than or equal to the critical value, 1<2, the system proceeds to step (6);
(6) adding the quotient 333 by a quotient of a quotient temporary storage device, 0, i.e. 333+0=333, the sum 333 is stored in the quotient temporary storage device;
(7) rotating the motor 2 to a calculated position in accordance with the quotient sum 333, and the system will then proceed to the step (2);
(2) inputting the commend pulse value 1000;
(3) multiplying 1000 by 1=1000, and dividing the sum by last digit gear ratio 3, 1000/3=333 (quotient) . . . 1 (remainder), wherein the remainder, 1, is added by the remainder of the remainder temporary storage device, 1, 1+1=2, the sum 2 is stored in the remainder temporary storage device;
(4) determining whether the sum of the remainder temporary storage device is greater than or equal to the critical value, 2=2, the system proceeds to step (5);
(5) adding the quotient 333 by 1, 333+1=334, and subtracting the sum of the remainder temporary storage device by the last digit of gear ratio, 2-3-1, the sum −1 is stored in the remainder temporary storage device;
(6) adding the quotient 334 by a quotient of a quotient temporary storage device 333, i.e. 334+333=667, the sum 667 is stored in the quotient temporary storage device;
(7) rotating the motor 2 to a calculated position in accordance with the quotient sum 667, and the system will proceed to the step (2);
(2) inputting the commend pulse value 1000;
(3) multiplying 1000 by 1=1000, and dividing the sum by last digit gear ratio 3, 1000/3=333 (quotient) . . . 1 (remainder), wherein the remainder 1 is added by the remainder of the remainder temporary storage device, 1+(−1)=0, the sum 0 is then stored in the remainder temporary storage device;
(4) determining whether the sum of the remainder temporary storage device is greater than or equal to the critical value, 0<2, the system proceeds to step (6);
(6) adding the quotient 333 by the quotient of the quotient temporary storage device, 667, i.e. 333+667=1000, the sum 1000 is stored in the quotient temporary storage device; and
(7) rotating the motor 2 to a calculated position in accordance with the quotient sum 1000, and the system will then proceed to the step (2);

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A method of locating a servo motor controller, comprising:
(1) dividing a last digit of a gear ratio by 2 to obtain a sum, and applying an round-to-even method to round the sum to its 1^{st} place (units place), either increasing it by 1 when a next digit is 5 or more, or leave it the same if the next digit is 4 or less, wherein the obtained sum of the division is used as a critical value;
(2) inputting a commend pulse value;
(3) multiplying the commend pulse value by a first digit of the gear ratio, and dividing the obtained quantity of the division by the last digit of the gear ratio to produce a quotient and a remainder, wherein the remainder is added to a remainder of a remainder temporary storage device to obtain a sum and the remainder sum is stored within the remainder temporary storage device;
(4) determining whether the sum of the remainder temporary storage device is greater than or equal to the critical value, if it is no, the system will proceed to step 6, otherwise the system will proceed to the following step;
(5) adding the quotient by 1, and subtracting the sum of the remainder temporary storage device by the last digit of gear ratio in such that the final result is stored within the remainder temporary storage device;
(6) adding the quotient by a quotient of a quotient temporary storage device, and saving the obtained quotient sum in the quotient temporary storage device; and
(7) rotating a motor to a calculated position according to the obtained quotient sum of the quotient temporary storage device, and then proceed to step (2).

2. The method of claim 1, wherein the pulse value is produced by a host controller, an internal memory or a signal processor.

3. The method of claim 1, wherein the calculation of the quotient and the remainder in step (3) can be processed via a hardware processor and a software processor.

4. The method of claim 1, wherein the calculation of the quotient and the remainder in step (3) can be processed via a hardware processor of a complex programmable logic device (CPLD), or a field programmable gate array (FPGA) or a application specific integrated circuit (ASIC).

5. The method of claim 1, wherein the gear ratio is produced by a feedback signal.
